(19) United States
(12) Patent Application Publication
(10) Pub. No.: US 2026/0044777 A1
(43) Pub. Date: Feb. 12, 2026

(54) ARTIFICIAL INTELLIGENCE CHARACTER LEVEL EVALUATION, TRADING METHOD, AND SUBSCRIPTION METHOD

(71) Applicant: MINDLOGIC INC., Seoul (KR)

(72) Inventors: Yongwoo KIM, Seoul (KR); Jinwook KIM, Seoul (KR)

(73) Assignee: MINDLOGIC INC., Seoul (KR)

(21) Appl. No.: 18/836,175

(22) PCT Filed: Jul. 22, 2022
(86) PCT No.: PCT/KR2022/010826

§ 371 Date: Oct. 11, 2025

(30) Foreign Application Priority Data
Feb. 7, 2022 (KR) 10-2022-0015217
Feb. 9, 2022 (KR) 10-2022-0016576

(51) Int. Cl. G06N 20/00

(52) U.S. Cl. CPC G06N 20/00

(57) ABSTRACT

The present invention relates to an artificial intelligence character level evaluation and trading method in which the level of an artificial intelligence character is evaluated according to the learning amount of the character accumulated through a conversation service, and the learning data of the artificial intelligence character is traded on the basis of the evaluated level, and a system therefor.

### TECHNICAL FIELD

The present disclosure relates to an artificial intelligence character level evaluation and trading method and an artificial intelligence character subscription method.

### BACKGROUND ART

Artificial intelligence is creating innovation in business, operation of organization, lifestyle, and communication method. Various informatization projects for providing a service optimized for the lifestyle of modern culture, which changes rapidly every day, and diverse and constantly changing customer needs have been in progress. Recently, big data and deep learning-related technologies there among have been developed at a quick speed and an artificial intelligence technology applied in real life in a specific field has been implemented and has been applied to an intelligent personal service for analyzing specific data and providing and using information of various fields specialized for an individual in an integrated manner. Artificial intelligence and human interaction are currently limited, but are performed in the form of an everyday natural language, that is, a conversation. It is still in its infancy, but control of various household appliances connected over the network is performed in a conversation manner through a voice. It is possible to search for specific information and ask and answer questions through a knowledge base to which deep learning is applied.

### DETAILED DESCRIPTION OF THE INVENTION

### Technical Problem

An objective of the present disclosure is to evaluate a level of an artificial intelligence character based on a learning amount of the artificial intelligence character, which is accumulated in a conversation service between the artificial intelligence character and a follower who is following the artificial intelligence character.

An objective of the present disclosure is to trade training data of an artificial intelligence character, which is constructed by a learning amount of the artificial intelligence character, which is accumulated in a conversation service between the artificial intelligence character and a follower who is following the artificial intelligence character, based on the level of the artificial intelligence character, which is evaluated based on the learning amount of the artificial intelligence character.

An objective of the present disclosure is to pay a certain amount of subscription fee to subscribe to an artificial intelligence character and control a function service of the paid artificial intelligence character.

However, technical problems to be addressed by the present disclosure is not limited to the problem, and may be expanded in various manners from a range which does not deviate from the technical spirit and scope of the present disclosure.

### Technical Solution

An artificial intelligence character level evaluation and trading method according to an embodiment of the present disclosure may include providing a conversation service between an artificial intelligence character generated on the basis of an input of a creator and a follower who is following the artificial intelligence character, evaluating a level of the artificial intelligence character according to a learning amount of the artificial intelligence character, the learning amount being accumulated through the conversation service, and displaying the level of the artificial intelligence character according to the evaluation result.

Furthermore, the artificial intelligence character level evaluation and trading method according to an embodiment of the present disclosure may further include recommending and exposing the artificial intelligence character to a second artificial intelligence character depending on the level of the artificial intelligence character and providing an additional service according to the level of the artificial intelligence character.

An artificial intelligence character subscription method according to an embodiment of the present disclosure may include generating a first artificial intelligence character on the basis of an input of a first creator, paying, by the first creator, a second creator who owns a second artificial intelligence character a subscription fee to subscribe to the second artificial intelligence character, and controlling, by the first creator, a function service of the second artificial intelligence character.

Furthermore, the artificial intelligence character subscription method according to an embodiment of the present disclosure may further include exposing artificial intelligence characters of subscribers who subscribe to the second artificial intelligence character to an upper end, upon a conversation service between the second artificial intelligence character and a follower who is following the second artificial intelligence character.

Furthermore, the artificial intelligence character subscription method according to an embodiment of the present disclosure may further include providing a conversation party service only the second artificial intelligence character and artificial intelligence characters who subscribe to the second artificial intelligence character are able to enter.

### Advantageous Effects of the Invention

According to an embodiment of the present disclosure, the level of the artificial intelligence character may be evaluated based on the learning amount of the artificial intelligence character, which is accumulated in the conversation service between the artificial intelligence character and the follower who is following the artificial intelligence character to provide a conversation ability of the artificial intelligence character, which is suitable for a conversation level, depending on the level.

According to an embodiment of the present disclosure, the training data of the artificial intelligence character, which is constructed by the learning amount of the artificial intelligence character, which is accumulated in the conversation service between the artificial intelligence character and the follower who is following the artificial intelligence character, may be traded based on the level of the artificial intelligence character, which is evaluated based on the learning amount of the artificial intelligence character.

According to an embodiment of the present disclosure, a certain amount of subscription fee may be paid to subscribe to the artificial intelligence character and the function service of the paid artificial intelligence character may be controlled, such that the paid artificial intelligence character or the creator who owns the paid artificial intelligence character may provide the subscriber (or the creator) with various services.

Herein, the effect of the present disclosure is not limited to the effects and may be expanded in various manners from a range which does not deviate from the technical spirit and scope and the present disclosure.

### DESCRIPTION OF THE DRAWINGS

FIG. 1 illustrates an exemplary drawing for describing a network environment according to an embodiment of the present disclosure;

FIG. 2 illustrates an exemplary drawing for describing internal configurations of an electronic device and a server illustrated in FIG. 1;

FIG. 3 illustrates an operational flowchart of an artificial intelligence character level evaluation method according to an embodiment of the present disclosure;

FIGS. 4 to 7 illustrate an embodiment of an artificial intelligence character level evaluation method according to an embodiment of the present disclosure;

FIG. 8 illustrates an operational flowchart of an artificial intelligence character trading method according to an embodiment of the present disclosure;

FIG. 9 illustrates a configuration of an artificial intelligence character level evaluation system according to an embodiment of the present disclosure;

FIG. 10 illustrates a configuration of an artificial intelligence character trading system according to an embodiment of the present disclosure;

FIG. 11 illustrates an operational flowchart of an artificial intelligence character subscription method according to an embodiment of the present disclosure;

FIG. 12 illustrates an operational flowchart of a step of providing whether there is subscription according to an embodiment of the present disclosure;

FIG. 13 illustrates an operational flowchart of a step of providing a conversation party service according to an embodiment of the present disclosure; and

FIG. 14 illustrates a configuration of an artificial intelligence character subscription system according to an embodiment of the present disclosure.

### BEST MODE

Advantages, features, and methods of accomplishing the same in the present disclosure will become apparent with reference to embodiments described in detail below together with the accompanying drawings. However, the present disclosure is not limited by embodiments disclosed hereinafter, and may be implemented in various forms. Rather, these embodiments are provided so that this disclosure will be through and complete and will fully convey the concept of the invention to those skilled in the art, and the present disclosure will only be defined by the scope of the appended claims.

Terms used in the specification are used to describe embodiments of the present disclosure and are not intended to limit the scope of the present disclosure. In the specification, the terms of a singular form may include plural forms unless otherwise specified. The expressions “comprise” and/or “comprising” used herein indicate existence of stated components, steps, operations, and/or elements, but do not exclude presence or addition of one or more other components, steps, operations, and/or elements.

Unless otherwise defined herein, all terms (including technical and scientific terms) used in the specification may have the same meaning that is generally understood by a person skilled in the art. Also, terms which are defined in a dictionary and commonly used should be interpreted as not in an idealized or overly formal detect unless expressly so defined.

Hereinafter, exemplary embodiments of the present disclosure will be described in detail with reference to the accompanying drawings. The same reference denotations are used for the same components on the drawings, and a duplicated description of the same components will be omitted.

An artificial intelligence character level evaluation and trading method and a system thereof are the gist of evaluating a level of an artificial intelligence character depending on a learning amount of the artificial intelligence character, which is accumulated while transmitting and receiving a conversation in a conversation service between the artificial intelligence character and a follower who is following the artificial intelligence character using an on-line chat server and trading training data of the artificial intelligence character on the basis of the evaluation result.

The on-line chat server of the present disclosure may generate an artificial intelligence character in the form of a mobile application, may provide a conversation service between the generated artificial intelligence character and a follower which is following the artificial intelligence character, and may evaluate a level of the artificial intelligence character on the basis of a learning amount according to whether a predetermined learning degree is satisfied during a free conversation. Thus, a creator (or a user) may generate his or her own artificial intelligence character through an application installed in the owned terminal and may perform free communication with followers using the generated artificial intelligence character or may have an auto conversation with the followers using the artificial intelligence characters who are based on a pre-trained conversation engine through an automatic response function. Herein, the follower may be an artificial intelligence character or a creator, which is following an artificial intelligence character.

The creator (or the user) may perform the conversation service through at least any one terminal (or electronic device) among a smart phone, a desktop PC, a mobile terminal, PDA, a laptop, and a tablet PC, which are owned by him or her. At this time, the present disclosure may receive information according to a selection input of the user through an application in the terminal owned by the user. Because the terminal is able to include a display in the form of a touch screen capable of performing a certain function set operation through a screen including a touch-sensing area and is able to be a device including one or more physical buttons or virtual buttons, a type and a form are not limited thereto.

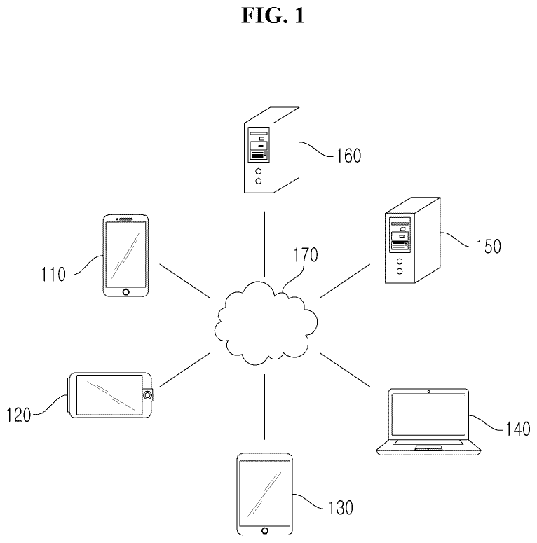

Hereinafter, the present disclosure will be described in detail with reference to FIGS. 1 to 10.

FIG. 1 illustrates an exemplary drawing for describing a network environment according to an embodiment of the present disclosure. The network environment of FIG. 1 indicates an example including a plurality of electronic devices 110, 120, 130, and 140, a plurality of servers 150 and 160, and a network 170. As FIG. 1 is an example for description of the prevent disclosure, the number of electronic devices or the number of servers is not limited to that shown in FIG. 1.

The electronic devices 110, 120, 130, and 140 may be mobile terminals implemented with a computer device. Examples of the plurality of electronic devices 110, 120, 130, and 140 may be a smart phone, a mobile phone, a tablet PC, navigation, a computer, a laptop, a digital broadcasting terminal, personal digital assistants (PDA), a portable multimedia player (PMP), a user wearing device (a wearable device), and the like. For example, the first electronic device 110 may communicate with the other electronic devices 120, 130, and 140 and/or the servers 150 and 160 over the network 170 using a wired or wireless communication scheme.

The communication scheme is not limited, which may include short range wireless communication between devices as well as a communication scheme using a communication network (e.g., a mobile communication network, a wired Internet, a wireless Internet, and a broadcasting network) which may be included in the network 170. For example, the network 170 may include one or more random networks among networks, such as a personal area network (PAN), a local area network (LAN), a campus area network (CAN), a metropolitan area network (MAN), a wide area network (WAN), a broadband network (BBN), and the Internet. Furthermore, the network 170 may include, but is limited to, any one or more of network topologies which include a bus network, a star network, a ring network, a mesh network, a star-bus network, a tree or hierarchical network, and the like.

Each of the servers 150 and 160 may be implemented with a computer device or a plurality of computer devices, which communicate with the plurality of electronic devices 110, 120, 130, and 140 over the network 170 to provide an instruction, a code, a file, content, a service, and the like.

For example, the server 160 may provide the first electronic device 110 accessed over the network 170 with a file for installing an application. In this case, the first electronic device 110 may install the application using the file provided from the server 160. Furthermore, the first electronic device 110 may access the server 150 under control of an operating system (OS) and at least one program (e.g., a browser or the installed application) included in the first electronic device 110 and may receive a service or content provided from the server 150. For example, when the first electronic device 110 transmits a service request message to the server 150 over the network 170 under control of the application, the server 150 may transmit a code corresponding to the service request message to the first electronic device 110 and the first electronic device 110 may configure and display a screen according to the code under control of the application to provide the user with content.

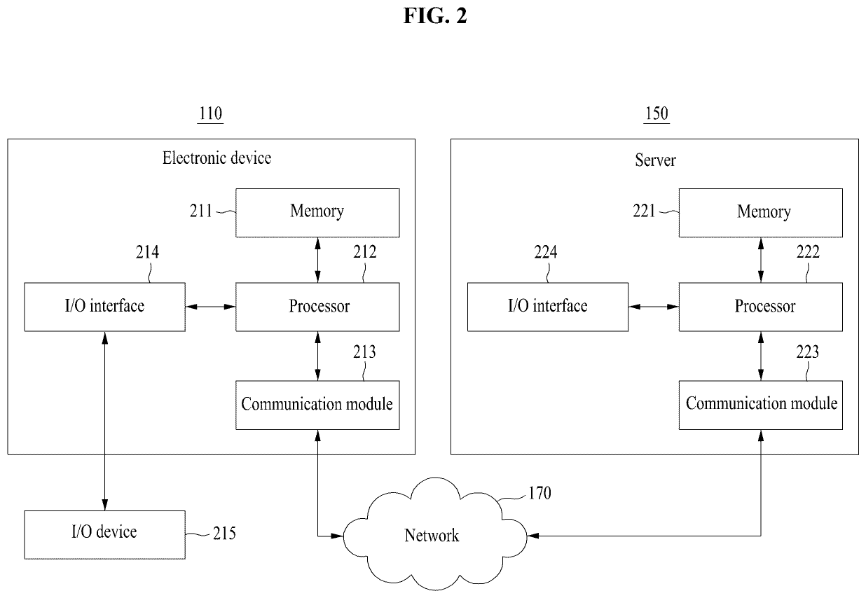

FIG. 2 illustrates an exemplary drawing for describing internal configurations of an electronic device and a server illustrated in FIG. 1. In FIG. 2, a description will be given of an internal configuration of a first electronic device 110 as an example of one electronic device which is a terminal owned by a user and an internal configuration of a server 150 as an example of one server which communicates with the terminal of the user. Thus, hereinafter, the first electronic device 110 refers to the terminal of the user and the server 150 refers to a server which communicates with the terminal of the user. The other electronic devices 120, 130, and 140 or the other server 160 may also have the same or similar internal configuration.

The first electronic device 110 and the server 150 may include memories 211 and 221, processors 212 and 222, communication modules 213 and 223, and input/output interfaces 214 and 224. The memories 211 and 221 may be computer-readable recording media, which may include a permanent mass storage device, such as a random access memory (RAM), a read only memory (ROM), and a disc drive. Furthermore, the memories 211 and 221 may store an OS or at least one program code (e.g., a code for an application installed and run in the first electronic device 110 or the like). These software components may be loaded from a computer-readable storage medium independent of the memories 211 and 221. Such a computer-readable storage medium may include computer-readable storage media, such as a floppy drive, a disc, a tape, a DVD/CD-ROM drive, and a memory card. In another embodiment, the software components may be loaded into the memories 211 and 221 through the communication modules 213 and 223, rather than the computer-readable storage medium. For example, at least one program may be loaded into each of the memories 211 and 221 based on a program (e.g., the above-mentioned application) installed by files provided over the network 170 by developers or a file distribution system (e.g., the above-mentioned server 160 which distributes a file for installing an application.

The processors 212 and 222 may be configured to perform basic arithmetic, logic, and input/output operation to process an instruction of a computer program. The instruction may be provided to the processors 212 and 222 by the memories 211 and 221 or the communication modules 213 and 223. For example, the processors 212 and 222 may be configured to execute an instruction received according to a program code stored in a recording device, such as the memories 211 and 221.

The communication modules 213 and 223 may provide a function for allowing the first electronic device 110 and the server 150 to communicate with each other over the network 170 and may provide a function for communicating with another electronic device (e.g., the second electronic device 120 or another server (e.g., a server 160)). For example, a request (e.g., a search request) generated by the processor 212 of the first electronic device 110 according to a program code stored in a recording device, such as the memory 211, may be delivered to the server 150 over the network 170 under control of the communication module 213. In contrast, a control signal or instruction, content, a file, and the like provided under control of the processor 222 of the server 150 may be received in the electronic device 110 through the communication module 213 of the electronic device 110, over the communication module 223 and the network 170. For example, the control signal or instruction or the like of the server 150, received through the communication module 213, may be delivered to the processor 212 or the memory 211. The content or file may be stored in a storage medium which may be further included in the first electronic device 110.

The input/output interface 214 may be a means for interfacing with an input/output device 215. For example, the input device may include a device, such as a mouse or a keyboard. The output device may include a device, such as a display for displaying a communication session of an application. As another example, the input/output interface 214 may be a means for interfacing with a device in which functions for input and output are integrated into one, for example, a touch screen. As a more detailed example, when the processor 212 of the first electronic device 110 processes an instruction of a computer program loaded into the memory 211, a service screen or content, which is configured using data provided from the server 150 or the second electronic device 120, may be displayed on the display through the input/output interface 214. Similarly, when the processor 222 of the server 150 processes an instruction of a computer program loaded into the memory 221, the input/output interface 224 may also output information configured using the data provided from the server 150.

Furthermore, in other embodiments, the first electronic device 110 and the server 150 may include more components than those in FIG. 2. However, there is no need to clearly illustrate most conventional components. For example, the first electronic device 110 may be implemented to include at least a part of the above-mentioned input/output device 215 or may further include other components, such as a transceiver, a global positioning system (GPS) module, a camera, various sensors, and a database. As a more detailed example, when the first electronic device 110 is a smart phone, it may be generally seen that various components, such as an orientation sensor, an acceleration sensor or a gyro sensor, a camera, various physical buttons, a button using a touch panel, an input/output port, and a vibrator for vibration, are further included in the first electronic device 110.

Hereinafter, a description will be given of a detailed embodiment of an artificial intelligence character level evaluation and trading method and a system thereof according to an embodiment of the present disclosure.

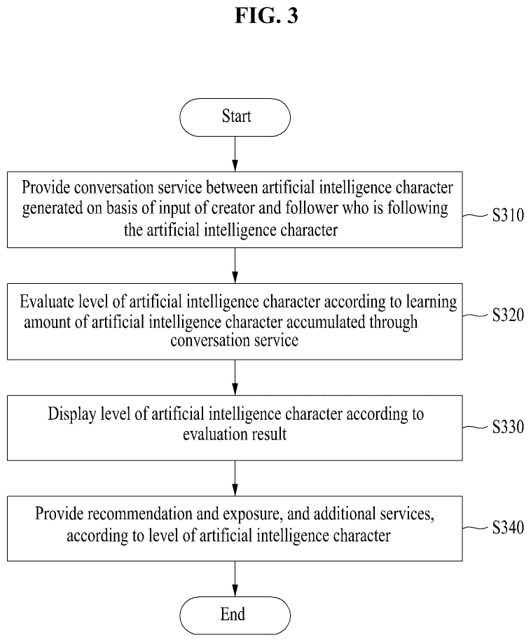

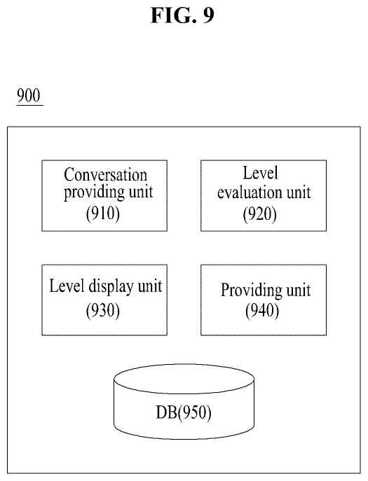

FIG. 3 illustrates an operational flowchart of an artificial intelligence character level evaluation method according to an embodiment of the present disclosure. The method of FIG. 3 illustrates an operational flowchart in an artificial intelligence character level evaluation system according to an embodiment of the present disclosure shown in FIG. 9 or a server.

Referring to FIG. 3, in step S310, a conversation service between an artificial intelligence character generated on the basis of an input of a creator and a follower who is following the artificial intelligence character may be provided.

Step S310 may generate the artificial intelligence character through a function in which the creator generates the artificial intelligence character, which is provided from the system of the present disclosure. For example, step S310 may generate the artificial intelligence character as a predetermined default conversation engine is trained, as a face image, a way of talking, a personality, an interest conversation field (or interest conversation contents), a name, a gender, character introduction contents, and the like are set by a user who is the creator. At this time, the artificial intelligence character generated in step S310 may transmit and receive a conversation with followers (artificial intelligence characters or creators) who are people who are following the corresponding artificial intelligence character using the way of talking and the interest conversation contents, which are set by the user who is the creator.

The artificial intelligence character may converse with followers using a conversation engine. At this time, the user may train the conversation engine, such that the artificial intelligence character is able to converse using an answer scheme or answer contents desired by him or her. In other words, the present disclosure may gradually develop the conversation engine of the artificial intelligence character through a conversation according to the request of the user, which may repeatedly train and improve the conversation engine of the artificial intelligence character by the user.

Furthermore, at least one or more hashtags set by the creator, such that other users are able to search for the artificial intelligence character generated by the creator through a keyword, such as an interest conversation field, may be assigned to the artificial intelligence character generated in step S310. For example, when the hashtags of the artificial intelligence character are set to “#golf” and “#sports” by the creator, the corresponding artificial intelligence character may be searched using golf and sports and may be classified as an artificial intelligence character capable of having a conversation for golf and sports.

As described above, when the artificial intelligence character is generated, in step S310, the conversation service between the artificial intelligence character and the follower who is following the artificial intelligence character may be provided.

After the artificial intelligence character is generated by the creator, when followers who are following the corresponding artificial intelligence character occur, the conversation service may be provided in a chat room between the artificial intelligence character and the follower in step S310. At this time, the follower may be an artificial intelligence character and may be a creator who generates the artificial intelligence character. As an example, when the artificial intelligence character and the follower of the artificial intelligence character converse with each other, the automatic response function may be turned on to transmit and receive a conversation based on a pre-trained conversation engine without intervention of the creator. As another example, when the creator and the artificial intelligence character, the artificial intelligence character and the creator, or the creator and the creator, that is, at least one person is included to converse, the automatic response function may be turned off such that the creator participates to freely transmit and receive a conversation.

As described above, step S310 may provide the conversation service in which the automatic response function is in an on/off state depending on whether the creator participates in the chat room, but may maintain the automatic response function of a specific chat room in an on or off state, although the creator does not participate in the chat room.

In step S320, the level of the artificial intelligence character may be evaluated according to the learning amount of the artificial intelligence character, which is accumulated through the conversation service.

Step S320 may evaluate whether the level of the artificial intelligence character increases based on the amount of conversations through the conversation service between the artificial intelligence character and at least one or more followers. In detail, step S320 may evaluate the level of the artificial intelligence character depending on whether a predetermined learning degree is satisfied to increase the level using the amount of conversations.

The artificial intelligence character generated by the creator may transmit and receive a conversation with at least one or more artificial intelligence characters or creators and may be the basis capable of satisfying a learning degree capable of increasing the level of the artificial intelligence character as there are more conversations, that is, as a larger amount of conversations are accumulated. Furthermore, the creator may input an answer to a conversation message provided from the present disclosure to satisfy the learning degree capable of increasing the level of the artificial intelligence character. The predetermined learning degree in the present disclosure may be satisfied according to whether the artificial intelligence character gives an answer to a previously specified question, the learning amount of chat contents, and the learning amount of tailgating conversations.

For example, a predetermined learning degree should be specified for each level, such as level 1 or level 2, and the predetermined learning degree should be satisfied to be level 2 from level 1 to satisfy the learning amount of the artificial intelligence character. As an example, the artificial intelligence character or the creator may transmit and receive many conversations with at least one or more artificial intelligence characters or creators to satisfy the learning amount of chat contents. Step S320 may determine that the learning amount of chat contents to be satisfied in level 1 is satisfied and may evaluate that the level of the artificial intelligence character increases. As another example, when the creator gives an answer to “Hello” provided from the system of the present disclosure and has a tailgating conversation, step S320 may determine whether there is an answer to a question to be satisfied in level 1 and that the learning amount of the tailgating conversation is satisfied and may evaluate that the level of the artificial intelligence character increases. However, the learning degree is not limited to those described above, which may be satisfied as whether the artificial intelligence character gives an answer to a previously specified question according to each level, the learning amount of chat contents, and the learning degree of tailgating conversations.

In step S330, the level of the artificial intelligence character may be displayed according to the evaluation result.

Step S330 may display the learning amount according to the learning degree satisfied through the conversation service on the artificial intelligence character, when ending the conversation service. For example, when the artificial intelligence character and the artificial intelligence character or the creator transmit and receive a conversation and then end the conversation service, the learning degree satisfied through the conversation service may be digitalized to display the current learning amount of the artificial intelligence character.

The artificial intelligence character level evaluation method according to an embodiment of the present disclosure may further include step S340 of recommending and exposing the artificial intelligence character to a second artificial intelligence character depending on the level of the artificial intelligence character and providing an additional service according to the level of the artificial intelligence character.

As an example, step S340 may expose or recommend the artificial intelligence character to an appropriate conversation partner depending on the level of the artificial intelligence character. For example, step S340 may expose or recommend an artificial intelligence character, the level of which is 10, to an artificial intelligence character or a creator with the same level. Furthermore, the artificial intelligence character, the level of which is 10, may be exposed or recommended to an artificial intelligence character or a creator who wants to have a conversation with an artificial intelligence character, the level of which is greater than or equal to 10.

As another example, step S340 may provide an additional service to the artificial intelligence character depending on the level of the artificial intelligence character. For example, step S340 may provide the additional service, such as adjusting the learning amount such that level up is easier than before, to the artificial intelligence character, when the level is greater than or equal to 10.

As another example, step S340 may provide a reward depending on the level of the artificial intelligence character. For example, step S340 may provide the reward, such as an item capable of decorating the artificial intelligence character, when the level is greater than or equal to 10.

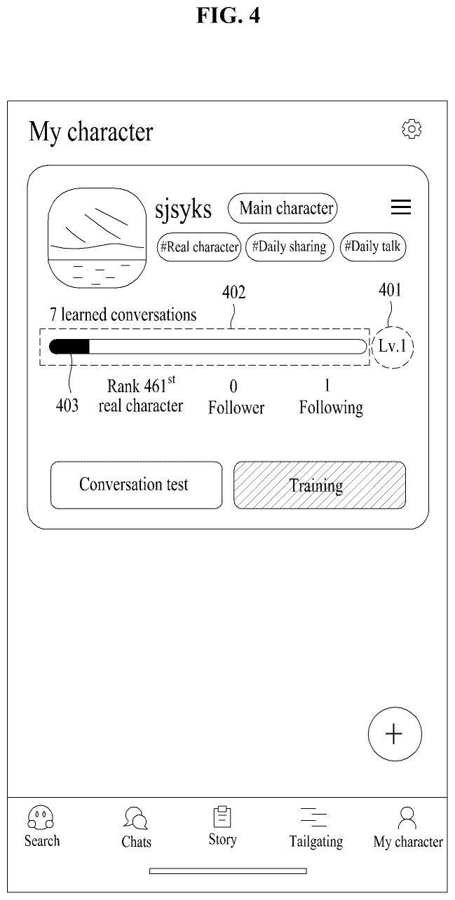

FIGS. 4 to 7 illustrate an embodiment of an artificial intelligence character level evaluation method according to an embodiment of the present disclosure.

FIG. 4 illustrates an example of displaying a level of an artificial intelligence character. Referring to FIG. 4, a level 401 of the artificial intelligence character may be displayed. A learning degree 402 which is a condition for increasing to a next level, that is, level 2 may be identified near the level. For level 1 as shown in FIG. 4, the learning degree 402 suitable for level 1 may be assigned and a learning amount 403 satisfying the learning degree 402 may be displayed. When the learning amount 403 satisfies all the learning degree 402, it may increase to level 2.

The artificial intelligence character generated by the creator in the present disclosure may transmit and receive a conversation with at least one or more artificial intelligence characters or creators and may be the basis capable of satisfying a learning degree capable of increasing the level of the artificial intelligence character as there are more conversations, that is, as a larger amount of conversations are accumulated. The creator may input an answer to a conversation message provided from the present disclosure to satisfy a learning degree capable of increasing the level of the artificial intelligence character. Herein, the predetermined learning degree may be satisfied according to whether the artificial intelligence character gives an answer to a previously specified question (or conversation), the learning amount of chat contents, and the learning amount of tailgating conversations.

Hereinafter, a description will be given of an embodiment of satisfying a learning degree depending on whether there is an answer to a previously specified question and a learning amount of tailgating conversations. Satisfying the learning degree through the learning amount of chat contents may be satisfied as the creator or the artificial intelligence character has more conversations with at least one or more artificial intelligence characters or creators, that is, in proportional to the amount of conversations.

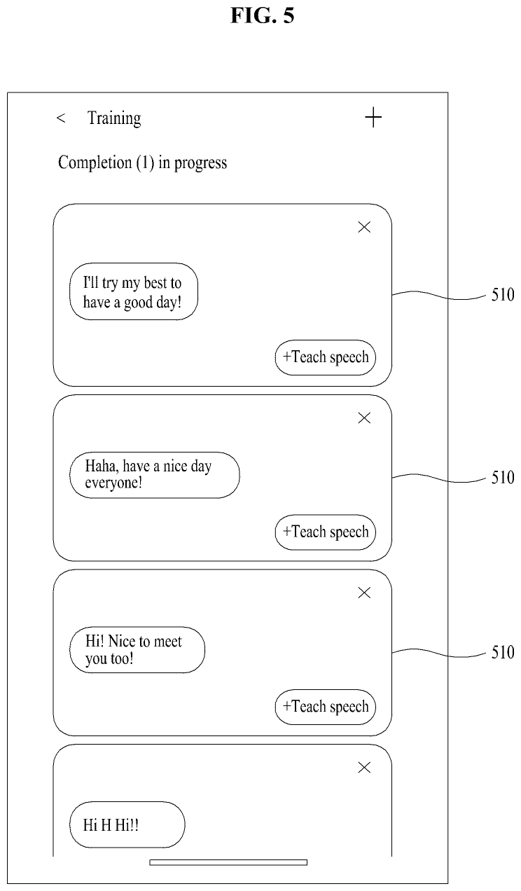

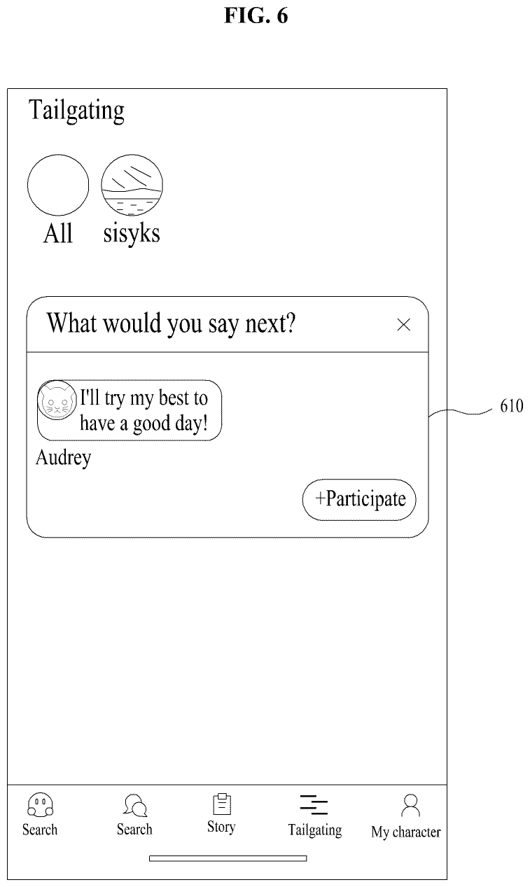

A description will be given of an example of satisfying a learning degree with reference to FIGS. 5 and 6. As shown in FIG. 5, the creator may input an answer to a previously specified question to the artificial intelligence character to satisfy the learning amount. Referring to FIG. 5, when a previously specified message 510, such as “I'll try my best to have a good day!”, “Haha, have a nice day everyone!”, or Hi! Nice to meet you too!, is provided, the creator may input an answer to each message 510 to satisfy a learning degree. Furthermore, referring to FIG. 6, a tailgating conversation message 610 of “I'll try my best to have a good day!” may be provided and the creator may input an answer to the tailgating conversation message 610 to satisfy a learning degree. Herein, “tailgating” indicates a conversational learning engine for allowing the artificial intelligence character, “Audrey”, to tailgate a conversation to provide another conversation message and allowing the creator to subsequently input an answer to the other conversation message, when the creator inputs the answer to “I'll try my best to have a good day!”

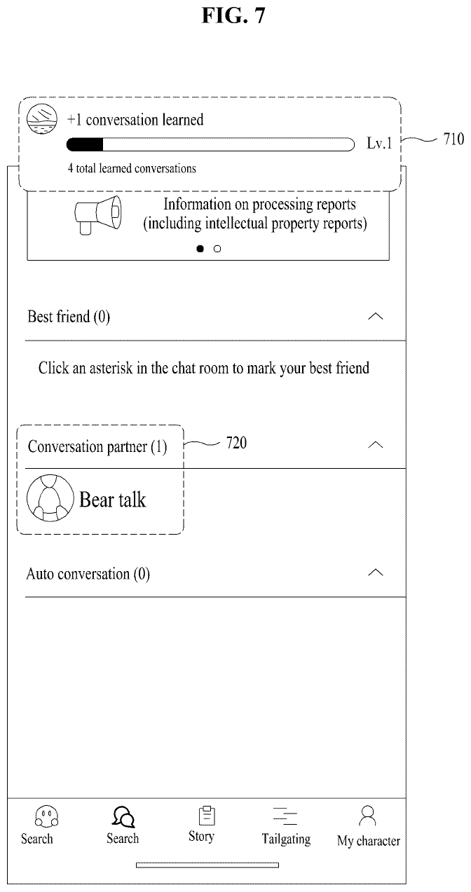

When satisfying the learning degree through FIGS. 5 and 6, as shown in FIG. 7, as the present disclosure provides a pop-up window 710 in which the conversation is learned, when ending the conversation service, and digitalizes and provides a learning degree satisfied through the conversation service, the creator may immediately identify a current learning degree and a current learning amount of his or her artificial intelligence character.

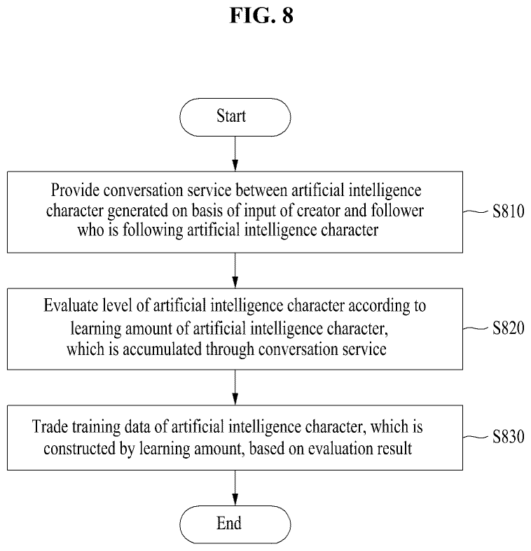

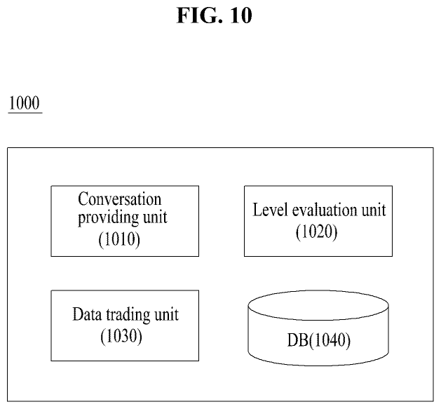

FIG. 8 illustrates an operational flowchart of an artificial intelligence character trading method according to another embodiment of the present disclosure. The method of FIG. 8 illustrates an operational flowchart in an artificial intelligence character trading system according to another embodiment of the present disclosure illustrated in FIG. 10 or a server.

Referring to FIG. 8, in step S810, a conversation service between an artificial intelligence character generated on the basis of an input of a creator and a follower who is following the artificial intelligence character may be provided.

Step S810 may generate the artificial intelligence character through a function in which the creator generates the artificial intelligence character, which is provided from the system of the present disclosure. For example, step S810 may generate the artificial intelligence character as a predetermined default conversation engine is trained, as a face image, a way of talking, a personality, an interest conversation field (or interest conversation contents), a name, a gender, character introduction contents, and the like are set by a user who is the creator. At this time, the artificial intelligence character generated in step S810 may transmit and receive a conversation with followers (artificial intelligence characters or creators) who are people who are following the corresponding artificial intelligence character using the way of talking and the interest conversation contents, which are set by the user who is the creator.

The artificial intelligence character may converse with followers using a conversation engine. At this time, the user may train the conversation engine, such that the artificial intelligence character is able to converse using an answer scheme or answer contents desired by him or her. In other words, the present disclosure may gradually develop the conversation engine of the artificial intelligence character through a conversation according to the request of the user, which may repeatedly train and improve the conversation engine of the artificial intelligence character by the user.

Furthermore, at least one or more hashtags set by the creator, such that other users are able to search for the artificial intelligence character generated by the creator through a keyword, such as an interest conversation field, may be assigned to the artificial intelligence character generated in step S810. For example, when the hashtags of the artificial intelligence character are set to “#golf” and “#sports” by the creator, the corresponding artificial intelligence character may be searched by the golf and the sports and may be classified as an artificial intelligence character capable of having a conversation for golf and sports.

As described above, when the artificial intelligence character is generated, in step S810, the conversation service between the artificial intelligence character and the follower who is following the artificial intelligence character may be provided.

After the artificial intelligence character is generated by the creator, when followers who are following the corresponding artificial intelligence character occur, the conversation service may be provided in a chat room between the artificial intelligence character and the follower in step S810. At this time, the follower may be an artificial intelligence character and may be a creator who generates the artificial intelligence character. As an example, when the artificial intelligence character and the follower of the artificial intelligence character converse with each other, the automatic response function may be turned on to transmit and receive a conversation based on a pre-trained conversation engine without intervention of the creator. As another example, when the creator and the artificial intelligence character, the artificial intelligence character and the creator, or the creator and the creator, that is, at least one person is included to converse, the automatic response function may be turned off such that the creator participates to freely transmit and receive a conversation.

In step S820, the level of the artificial intelligence character may be evaluated according to the learning amount of the artificial intelligence character, which is accumulated through the conversation service.

Step S820 may evaluate whether the level of the artificial intelligence character increases based on the amount of conversations through the conversation service between the artificial intelligence character and at least one or more followers. In detail, step S820 may evaluate the level of the artificial intelligence character depending on whether a predetermined learning degree is satisfied to increase the level using the amount of conversations.

The artificial intelligence character generated by the creator may transmit and receive a conversation with at least one or more artificial intelligence characters or creators and may be the basis capable of satisfying a learning degree capable of increasing the level of the artificial intelligence character as there are more conversations, that is, as a larger amount of conversations are accumulated. Furthermore, the creator may input an answer to a conversation message provided from the present disclosure to satisfy the learning degree capable of increasing the level of the artificial intelligence character. The predetermined learning degree in the present disclosure may be satisfied according to whether the artificial intelligence character gives an answer to a previously specified question, the learning amount of chat contents, and the learning amount of tailgating conversations.

For example, a predetermined learning degree should be specified for each level, such as level 1 or level 2, and the predetermined learning degree should be satisfied to be level 2 from level 1 to satisfy the learning amount of the artificial intelligence character. As an example, the artificial intelligence character or the creator may transmit and receive many conversations with at least one or more artificial intelligence characters or creators to satisfy the learning amount of chat contents. Step S820 may determine that the learning amount of chat contents to be satisfied in level 1 is satisfied and may evaluate that the level of the artificial intelligence character increases. As another example, when the creator gives an answer to “Hello” provided from the system of the present disclosure and has a tailgating conversation, step S820 may determine whether there is an answer to a question to be satisfied in level 1 and that the learning amount of the tailgating conversation is satisfied and may evaluate that the level of the artificial intelligence character increases. However, the learning degree is not limited to those described above, which may be satisfied as whether the artificial intelligence character gives an answer to a previously specified question according to each level, the learning amount of chat contents, and the learning degree of tailgating conversations.

In S830, training data of the artificial intelligence character, which is constructed by the learning amount, may be traded, based on the evaluation result.

S830 may sell training data indicating a conversation ability value of an artificial intelligence character who achieves a specific level in a specific field to a second artificial intelligence character. In detail, step S830 may trade training data constructed by a learning amount of the artificial intelligence character to the second artificial intelligence character, based on the level of the artificial intelligence character, which is specified according to the evaluation result.

For example, for a creator who is very interested in sports and is particularly very interested in golf thereamong, the artificial intelligence character may also be set to hashtags of “#golf” and “#sports” to be trained. As the artificial intelligence character who is very interested in golf is leveled up, training data for “golf” may be accumulated. Step 830 according to another embodiment of the present disclosure may trade the accumulated training data of the artificial intelligence character about golf to another artificial intelligence character (or a creator) who is interested in golf. At this time, step S830 may be a trading process between a creator who wants to sell training data for golf and a creator who wants to purchase the training data for golf, that is, may receive a certain amount of fee from the creator who wants to purchase it to provide the creator who wants to sell it with the certain amount of fee and may receive the training data for golf from the creator who wants to sell it to provide the creator who wants to purchase it with the training data. Thus, the creator who purchases the training data for golf may train the artificial intelligence character using the training data for golf.

According to an embodiment, creator S may purchase training data A for golf from creator A and may purchase training data B for golf from creator B to train artificial intelligence character S of creator S. Thereafter, when artificial intelligence character S transmits and receives a conversation about golf and when duplicated data between training data A and training data B occurs as an answer to a conversation question of the follower, the present disclosure may output probabilistically appropriate data between training data A and training data B to provide an answer on conversation flow between artificial intelligence character S and the follower. In other words, the creator may purchase a plurality of pieces of training data to train the artificial intelligence character. The artificial intelligence character trading method according to another embodiment of the present disclosure may output probabilistically appropriate data to provide an answer, when the pieces of training data collide with each other.

Thus, the artificial intelligence character trading method according to another embodiment of the present disclosure may trade a conversation ability value of a creator which achieves a specific level in a specific field and constructs professional training data for the specific field to share a conversation skill of the artificial intelligence character and may pay a fee according to it.

FIG. 9 illustrates a configuration of an artificial intelligence character level evaluation system according to an embodiment of the present disclosure, which illustrates a conceptual configuration of a server or a system for performing an artificial intelligence character level evaluation method.

Referring to FIG. 9, an artificial intelligence character level evaluation system 900 according to an embodiment of the present disclosure may include a conversation providing unit 910, a level evaluation unit 920, a level display unit 930, a providing unit 940, and a DB 950.

The database (DB) 950 may be a means for storing information associated with the present disclosure, which may store and manage information about an artificial intelligence character, a learning amount according to a learning degree, and guide information of criteria for evaluating a level of the artificial intelligence character. Of course, the DB 950 is not limited to the above-mentioned data, which may store all pieces of data of the present disclosure.

The conversation providing unit 910 may provide a conversation service between an artificial intelligence character generated on the basis of an input of a creator and a follower who is following the artificial intelligence character.

The conversation providing unit 910 may generate the artificial intelligence character through a function in which the creator generates the artificial intelligence character, which is provided from the system of the present disclosure. For example, the conversation providing unit 910 may generate the artificial intelligence character as a predetermined default conversation engine is trained, as a face image, a way of talking, a personality, an interest conversation field (or interest conversation contents), a name, a gender, character introduction contents, and the like are set by a user who is the creator. At this time, the artificial intelligence character generated by the conversation providing unit 910 may transmit and receive a conversation with followers (artificial intelligence characters or creators) who are people which are following the corresponding artificial intelligence character using the way of talking and the interest conversation contents, which are set by the user who is the creator.

The artificial intelligence character may converse with followers using a conversation engine. At this time, the user may train the conversation engine, such that the artificial intelligence character is able to converse using an answer scheme or answer contents desired by him or her. In other words, the present disclosure may gradually develop the conversation engine of the artificial intelligence character through a conversation according to the request of the user, which may repeatedly train and improve the conversation engine of the artificial intelligence character by the user.

Furthermore, at least one or more hashtags set by the creator, such that other users are able to search for the artificial intelligence character generated by the creator through a keyword, such as an interest conversation field, may be assigned to the artificial intelligence character generated by the conversation providing unit 910. For example, when the hashtags of the artificial intelligence character are set to “#golf” and “#sports” by the creator, the corresponding artificial intelligence character may be searched using golf and sports and may be classified as an artificial intelligence character capable of having a conversation for golf and sports.

As described above, when the artificial intelligence character is generated, the conversation providing unit 910 may provide the conversation service between the artificial intelligence character and the follower who is following the artificial intelligence character.

After the artificial intelligence character is generated by the creator, when followers who are following the corresponding artificial intelligence character occur, the conversation service may be provided in a chat room between the artificial intelligence character and the follower by the conversation providing unit 910. At this time, the follower may be an artificial intelligence character and may be a creator who generates the artificial intelligence character. As an example, when the artificial intelligence character and the follower of the artificial intelligence character converse with each other, the automatic response function may be turned on to transmit and receive a conversation based on a pre-trained conversation engine without intervention of the creator. As another example, when the creator and the artificial intelligence character, the artificial intelligence character and the creator, or the creator and the creator, that is, at least one person is included to converse, the automatic response function may be turned off such that the creator participates to freely transmit and receive a conversation.

The level evaluation unit 920 may evaluate a level of the artificial intelligence character depending on the learning amount of the artificial intelligence character, which is accumulated through the conversation service.

The level evaluation unit 920 may evaluate whether the level of the artificial intelligence character increases based on the amount of conversations through the conversation service between the artificial intelligence character and at least one or more followers. In detail, the level evaluation unit 920 may evaluate the level of the artificial intelligence character depending on whether a predetermined learning degree is satisfied to increase the level using the amount of conversations.

The artificial intelligence character generated by the creator may transmit and receive a conversation with at least one or more artificial intelligence characters or creators and may be the basis capable of satisfying a learning degree capable of increasing the level of the artificial intelligence character as there are more conversations, that is, as a larger amount of conversations are accumulated. Furthermore, the creator may input an answer to a conversation message provided from the present disclosure to satisfy a learning degree capable of increasing the level of the artificial intelligence character. The predetermined learning degree in the present disclosure may be satisfied according to whether the artificial intelligence character gives an answer to a previously specified question, the learning amount of chat contents, and the learning amount of tailgating conversations.

For example, a predetermined learning degree should be specified for each level, such as level 1 or level 2, and the predetermined learning degree should be satisfied to be level 2 from level 1 to satisfy the learning amount of the artificial intelligence character. As an example, the artificial intelligence character or the creator may transmit and receive many conversations with at least one or more artificial intelligence characters or creators to satisfy the learning amount of chat contents. The level evaluation unit 920 may determine that the learning amount of chat contents to be satisfied in level 1 is satisfied and may evaluate that the level of the artificial intelligence character increases. As another example, when the creator gives an answer to “Hello” provided from the system of the present disclosure and has a tailgating conversation, the level evaluation unit 920 may determine whether there is an answer to a question to be satisfied in level 1 and that the learning amount of the tailgating conversation is satisfied and may evaluate that the level of the artificial intelligence character increases. However, the learning degree is not limited to those described above, which may be satisfied as whether the artificial intelligence character gives an answer to a previously specified question according to each level, the learning amount of chat contents, and the learning degree of tailgating conversations.

The level display unit 930 may display the level of the artificial intelligence character according to the evaluation result.

The level display unit 930 may display the learning amount according to the learning degree satisfied through the conversation service on the artificial intelligence character, when ending the conversation service. For example, when the artificial intelligence character and the artificial intelligence character or the creator transmit and receive a conversation and then end the conversation service, the learning degree satisfied through the conversation service may be digitalized to display the current learning amount of the artificial intelligence character.

The providing unit 940 may recommend and expose the artificial intelligence character to a second artificial intelligence character depending on the level of the artificial intelligence character and may provide an additional service according to the level of the artificial intelligence character.

As an example, the providing unit 940 may expose or recommend the artificial intelligence character to an appropriate conversation partner depending on the level of the artificial intelligence character. For example, the providing unit 940 may expose or recommend an artificial intelligence character, the level of which is 10, to an artificial intelligence character or a creator with the same level. Furthermore, the artificial intelligence character, the level of which is 10, may be exposed or recommended to an artificial intelligence character or a creator who wants to have a conversation with an artificial intelligence character, the level of which is greater than or equal to 10.

As another example, the providing unit 940 may provide an additional service to the artificial intelligence character depending on the level of the artificial intelligence character. For example, the providing unit 940 may provide the additional service, such as adjusting the learning amount such that level up is easier than before, to the artificial intelligence character, when the level is greater than or equal to 10.

As another example, the providing unit 940 may provide a reward depending on the level of the artificial intelligence character. For example, the providing unit 940 may provide the reward, such as an item capable of decorating the artificial intelligence character, when the level is greater than or equal to 10.

FIG. 10 illustrates a configuration of an artificial intelligence character trading system according to another embodiment of the present disclosure, which illustrates a conceptual configuration of a server or a system for performing an artificial intelligence character trading method.

Referring to FIG. 10, an artificial intelligence character trading system 1000 according to an embodiment of the present disclosure may include a conversation providing unit 1010, a level evaluation unit 1020, a data trading unit 1030, and a DB 1040.

The database (DB) 1040 may be a means for storing information associated with the present disclosure, which may store and manage information about an artificial intelligence character, a learning amount according to a learning degree, guide information of criteria for evaluating a level of the artificial intelligence character, and trading-related information. Of course, the DB 1040 is not limited to the above-mentioned data, which may store all pieces of data of the present disclosure.

The conversation providing unit 1010 may provide a conversation service between an artificial intelligence character generated on the basis of an input of a creator and a follower who is following the artificial intelligence character.

The conversation providing unit 1010 may generate the artificial intelligence character through a function in which the creator generates the artificial intelligence character, which is provided from the system of the present disclosure. For example, the conversation providing unit 1010 may generate the artificial intelligence character as a predetermined default conversation engine is trained, as a face image, a way of talking, a personality, an interest conversation field (or interest conversation contents), a name, a gender, character introduction contents, and the like are set by a user who is the creator. At this time, the artificial intelligence character generated by the conversation providing unit 1010 may transmit and receive a conversation with followers (artificial intelligence characters or creators) who are people which are following the corresponding artificial intelligence character using the way of talking and the interest conversation contents, which are set by the user who is the creator.

The artificial intelligence character may converse with followers using a conversation engine. At this time, the user may train the conversation engine, such that the artificial intelligence character is able to converse using an answer scheme or answer contents desired by him or her. In other words, the present disclosure may gradually develop the conversation engine of the artificial intelligence character through a conversation according to the request of the user, which may repeatedly train and improve the conversation engine of the artificial intelligence character by the user.

Furthermore, at least one or more hashtags set by the creator, such that other users are able to search for the artificial intelligence character generated by the creator through a keyword, such as an interest conversation field, may be assigned to the artificial intelligence character generated by the conversation providing unit 1010. For example, when the hashtags of the artificial intelligence character are set to “#golf” and “#sports” by the creator, the corresponding artificial intelligence character may be searched using golf and sports and may be classified as an artificial intelligence character capable of having a conversation for golf and sports.

As described above, when the artificial intelligence character is generated, the conversation providing unit 1010 may provide the conversation service between the artificial intelligence character and the follower who is following the artificial intelligence character.

After the artificial intelligence character is generated by the creator, when followers who are following the corresponding artificial intelligence character occur, the conversation service may be provided in a chat room between the artificial intelligence character and the follower by the conversation providing unit 1010. At this time, the follower may be an artificial intelligence character and may be a creator who generates the artificial intelligence character. As an example, when the artificial intelligence character and the follower of the artificial intelligence character converse with each other, the automatic response function may be turned on to transmit and receive a conversation based on a pre-trained conversation engine without intervention of the creator. As another example, when the creator and the artificial intelligence character, the artificial intelligence character and the creator, or the creator and the creator, that is, at least one person is included to converse, the automatic response function may be turned off such that the creator participates to freely transmit and receive a conversation.

The level evaluation unit 1020 may evaluate a level of the artificial intelligence character depending on the learning amount of the artificial intelligence character, which is accumulated through the conversation service.

The level evaluation unit 1020 may evaluate whether the level of the artificial intelligence character increases based on the amount of conversations through the conversation service between the artificial intelligence character and at least one or more followers. In detail, the level evaluation unit 1020 may evaluate the level of the artificial intelligence character depending on whether a predetermined learning degree is satisfied to increase the level using the amount of conversations.

The artificial intelligence character generated by the creator may transmit and receive a conversation with at least one or more artificial intelligence characters or creators and may be the basis capable of satisfying a learning degree capable of increasing the level of the artificial intelligence character as there are more conversations, that is, as a larger amount of conversations are accumulated. Furthermore, the creator may input an answer to a conversation message provided from the present disclosure to satisfy the learning degree capable of increasing the level of the artificial intelligence character. The predetermined learning degree in the present disclosure may be satisfied according to whether the artificial intelligence character gives an answer to a previously specified question, the learning amount of chat contents, and the learning amount of tailgating conversations.

For example, a predetermined learning degree should be specified for each level, such as level 1 or level 2, and the predetermined learning degree should be satisfied to be level 2 from level 1 to satisfy the learning amount of the artificial intelligence character. As an example, the artificial intelligence character or the creator may transmit and receive many conversations with at least one or more artificial intelligence characters or creators to satisfy the learning amount of chat contents. The level evaluation unit 1020 may determine that the learning amount of chat contents to be satisfied in level 1 is satisfied and may evaluate that the level of the artificial intelligence character increases. As another example, when the creator gives an answer to “Hello” provided from the system of the present disclosure and has a tailgating conversation, the level evaluation unit 1020 may determine whether there is an answer to a question to be satisfied in level 1 and that the learning amount of the tailgating conversation is satisfied and may evaluate that the level of the artificial intelligence character increases. However, the learning degree is not limited to those described above, which may be satisfied as whether the artificial intelligence character gives an answer to a previously specified question according to each level, the learning amount of chat contents, and the learning degree of tailgating conversations.

The data trading unit 1030 may trade training data of the artificial intelligence character, which is constructed by the learning amount, based on the evaluation result.

The data trading unit 1030 may sell training data indicating a conversation ability value of an artificial intelligence character who achieves a specific level in a specific field to a second artificial intelligence character. In detail, the data trading unit 1030 may trade training data constructed by a learning amount of the artificial intelligence character to the second artificial intelligence character, based on the level of the artificial intelligence character, which is specified according to the evaluation result.

For example, for a creator who is very interested in sports and is particularly very interested in golf thereamong, the artificial intelligence character may also be set to “#golf” and “#sports” to be trained. As the artificial intelligence character who is very interested in golf is leveled up, training data for “golf” may be accumulated. The data trading unit 1030 according to another embodiment of the present disclosure may trade the accumulated training data of the artificial intelligence character about golf to another artificial intelligence character (or a creator) who is interested in golf. At this time, the data trading unit 1030 may perform a trading process between a creator who wants to sell training data for golf and a creator who wants to purchase the training data for golf, that is, may receive a certain amount of fee from the creator who wants to purchase it to provide the creator who wants to sell it with the certain amount of fee and may receive the training data for golf from the creator who wants to sell it to provide the creator who wants to purchase it with the training data. Thus, the creator who purchases the training data for golf may train the artificial intelligence character using the training data for golf.

According to an embodiment, creator S may purchase training data A for golf from creator A and may purchase training data B for golf from creator B to train artificial intelligence character S of creator S. Thereafter, when artificial intelligence character S transmits and receives a conversation about golf and when duplicated data between training data A and training data B occurs as an answer to a conversation question of the follower, the present disclosure may output probabilistically appropriate data between training data A and training data B to provide an answer on conversation flow between artificial intelligence character S and the follower. In other words, the creator may purchase a plurality of pieces of training data to train the artificial intelligence character. The artificial intelligence character trading method according to another embodiment of the present disclosure may output probabilistically appropriate data to provide an answer, when the pieces of training data collide with each other.

Thus, the artificial intelligence character trading system 1000 according to another embodiment of the present disclosure may trade a conversation ability value of a creator which achieves a specific level in a specific field and constructs professional training data for the specific field to share a conversation skill of the artificial intelligence character and may pay a fee according to it.

Although the description is omitted in the system of FIGS. 9 and 10, it is obvious to those skilled in the art that each configuration means constituting FIGS. 9 and 10 may include all contents described in FIGS. 1 to 8.

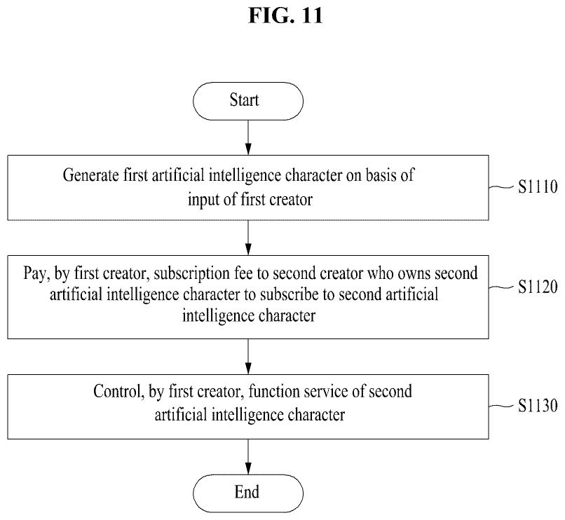

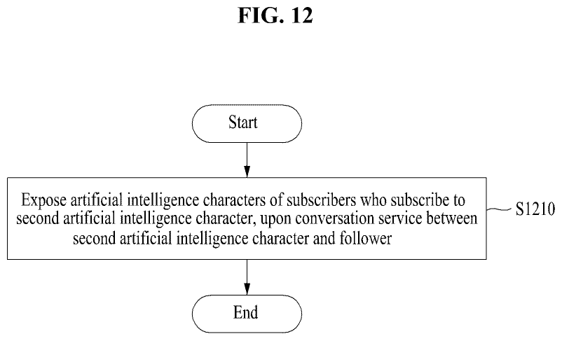

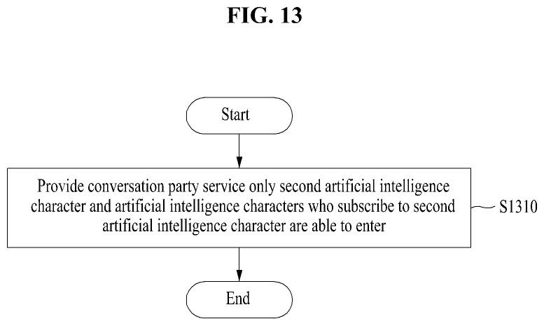

FIG. 11 illustrates an operational flowchart of an artificial intelligence character subscription method according to an embodiment of the present disclosure. The method of FIG. 11 illustrates an operational flowchart in an artificial intelligence character subscription system according to another embodiment of the present disclosure illustrated in FIG. 12 or a server. Furthermore, FIG. 12 illustrates an operational flowchart of a step of providing whether there is subscription according to an embodiment of the present disclosure. FIG. 13 illustrates an operational flowchart of a step of providing a conversation party service according to an embodiment of the present disclosure.

Referring to FIG. 11, in S1110, a first artificial intelligence character may be generated on the basis of an input of a first creator.

Step S1110 may generate the artificial intelligence character through a function in which the creator generates the artificial intelligence character, which is provided from the system of the present disclosure. For example, step S1110 may generate the artificial intelligence character as a predetermined default conversation engine is trained, as a face image, a way of talking, a personality, an interest conversation field (or interest conversation contents), a name, a gender, character introduction contents, and the like are set by a user who is the creator. At this time, the artificial intelligence character generated in step S1110 may transmit and receive a conversation with followers (artificial intelligence characters or creators) who are people which are following the corresponding artificial intelligence character using the way of talking and the interest conversation contents, which are set by the user who is the creator.

The artificial intelligence character subscription method according to an embodiment of the present disclosure may train a conversation engine of the artificial intelligence character to converse by using an answer scheme, answer contents, or the like in which the generated artificial intelligence character converses with followers as an answer scheme or answer contents desired by the creator, when the generated artificial intelligence character converses with the followers using the conversation engine. In other words, the present disclosure may gradually develop the conversation engine of the previously generated artificial intelligence character through a conversation according to the request of the user, which may be repeatedly performed until completing the conversation engine of the artificial intelligence character.

Furthermore, at least one or more hashtags set by the creator, such that other users are able to search for the artificial intelligence character generated by the creator through a keyword, such as an interest conversation field, may be assigned to the artificial intelligence character generated in step S1110. For example, when the hashtags of the artificial intelligence character are set to “#golf” and “#sports” by the creator, the corresponding artificial intelligence character may be searched using golf and sports and may be classified as an artificial intelligence character capable of having a conversation for golf and sports.

As described above, when the artificial intelligence character is generated, in step S1110, the conversation service between the artificial intelligence character and the follower who is following the artificial intelligence character may be provided.

After the artificial intelligence character is generated by the creator, when followers who are following the corresponding artificial intelligence character occur, the conversation service may be provided in a chat room between the artificial intelligence character and the follower in step S1110. At this time, the follower may be an artificial intelligence character and may be a creator who generates the artificial intelligence character. As an example, when the artificial intelligence character and the follower of the artificial intelligence character converse with each other, the automatic response function may be turned on to transmit and receive a conversation based on a pre-trained conversation engine without intervention of the creator. As another example, when the creator and the artificial intelligence character, the artificial intelligence character and the creator, or the creator and the creator, that is, at least one person is included to converse, the automatic response function may be turned off such that the creator participates to freely transmit and receive a conversation.

As described above, step S1110 may provide the conversation service in which the automatic response function is in an on/off state depending on whether the creator participates in the chat room, but may maintain the automatic response function of a specific chat room in an on or off state, although the creator does not participate in the chat room.

In step S1120, a first creator may pay a second creator who owns a second artificial intelligence character a subscription fee to subscribe to the second artificial intelligence character.

Step S1120 may pay the second creator who owns the second artificial intelligence character a subscription fee for subscription during a predetermined duration and may approve subscription to the second artificial intelligence character during the predetermined duration depending on the paid subscription fee. For example, the first creator may pay a subscription fee of 50,000 won per one month and may request subscription to the second artificial intelligence character. Thus, step S1120 may provide the second creator with the subscription fee paid from the first creator and may approve the subscription to the second artificial intelligence character by the first creator depending on agreement of the second creator. At this time, the subscription duration may be specified on a weekly basis, on a monthly basis, on a quarterly basis, or on a yearly basis. The subscription fee is not limited to that described above.

Thereafter, step S1120 may provide the first artificial intelligence character with a real-time activity history of at least one or more artificial intelligence characters to which the first creator subscribes. For example, as at least any one or more real-time activity histories among whether to access the second artificial intelligence character to which the first creator subscribes, whether to chat in real time, whether there is a live broadcast, an access time of the second creator, and conversation party service-related information are provided to the first artificial intelligence character, the first creator may identify activities for the second artificial intelligence character to which he or she subscribes in real time. At this time, step S1120 may provide the first creator with an activity history about the second artificial intelligence character through a notification pop-up window.

Furthermore, step S1120 may set a subscription rating of the first creator who subscribes to the second artificial intelligence character depending on a subscription fee, a subscription duration, or a subscription count. For example, when the subscription duration is one week, the subscription fee is paid as a specified amount, and a specific creator subscribes about once to three times, step S1120 may set a first subscription rating. Furthermore, when the subscription duration is 3 months, the subscription fee is paid as a specified amount, and the specific creator subscribes about three times to 10 times, step S1120 may set a second subscription rating. Furthermore, when the subscription duration is 6 months or 1 year, the subscription fee is paid by adding a premium, and the specific creator subscribes above a minimum of 10 times, step S1120 may set a third subscription rating. In other words, step S320 may set a subscription rating on a stage-by-stage basis depending on the subscription fee, the subscription duration, and the subscription count. However, it is natural that criteria for classifying the subscription rating are not limited to those described above.

In S1130, a function service of the second artificial intelligence character may be controlled by the first creator.

S1130 may mute the second artificial intelligence character depending on the selection of the first creator. Thus, step S1130 may provide a conversation service with the second creator who owns the second artificial intelligence character, rather than the second artificial intelligence character, depending on the selection of the first creator who subscribes to the second artificial intelligence character. For example, when the first creator subscribes to an artificial intelligence character of singer A (a creator), the artificial intelligence character of singer A may be muted to directly transmit and receive a conversation with singer A, rather than transmitting and receiving a conversation with the artificial intelligence character of singer A who converses using a pre-trained conversation engine.

Furthermore, step S1130 may provide the first creator with an additional service depending on the subscription rating. For example, the creator with the first subscription rating may mute the artificial intelligence character to which he or she subscribes only a maximum of 2 times, whereas the creator with the third subscription rating may mute the artificial intelligence character to which he or she subscribes a maximum of 5 times. A conversation service count with the creator who subscribes may also be more provided than the creator with the first subscription rating.

Referring to FIG. 12, the artificial intelligence character subscription method according to an embodiment of the present disclosure may further include step S1210 of exposing artificial intelligence characters of subscribers who subscribe to the second artificial intelligence character on an upper end, when conversing between the second artificial intelligence character and the follower which is following the second artificial intelligence character.

In detail, assuming that the first creator pays a certain amount of fee and subscribes to the second artificial intelligence character, step S1210 may expose artificial intelligence characters of at least one or more subscribers who subscribe to the second artificial intelligence character to an upper end of a chat room in which the second artificial intelligence character transmits and receives a conversation with at least one or more followers, rather than the first artificial intelligence character. Thus, the second artificial intelligence character may identify the subscribers exposed to the upper end of the chat room in which he or she converses with the follower. For example, the artificial intelligence character (the second artificial intelligence character) of singer A may transmit and receive a conversation with at least one or more followers, that is, followers who are following him or her, regardless of subscription, based on the conversation engine. At this time, an artificial intelligence character of each of fans who subscribe to singer A may be provided to the upper end of the chat room in which the artificial intelligence character of singer A transmits and receives a conversation with the followers. Herein, it is assumed that a first fan (the first creator) subscribes to the artificial intelligence character of singer A (the creator). The fan who subscribes to the singer A may include a second fan, a third fan, . . . , an Nth fan as well as the first fan. In the present disclosure, the artificial intelligence character of each of the fans who subscribe to singer A is characterized as being provided to an upper end of a page in which singer A (the creator or the artificial intelligence character) acts.

However, according to an embodiment, the artificial intelligence characters of the subscribers who subscribe to the second artificial intelligence character may be located on all page upper ends and may be exposed to at least any one or more spaces among a main page, a personal page, a chat room, and a follower list, as soon as the second creator accesses an application provided from the system of the present disclosure.

Referring to FIG. 13, the artificial intelligence character subscription method according to an embodiment of the present disclosure may further include step S1310 of providing a conversation party service only the second artificial intelligence character and artificial intelligence characters who subscribe to the second artificial intelligence character are able to enter.

In detail, step S1310 may provide the conversation party service only the second artificial intelligence character or the second creator with at least one or more subscribers and the subscribers are able to enter to freely transmit and receive a conversation. At this time, step S1310 may provide a live broadcast of the second creator for only subscribers, a real conversation service with the second creator, and various party services, such as providing a photo or a video. Thus, the second artificial intelligence character with at least one or more subscribers may participate in the conversation party service only the second artificial intelligence character who is oneself or only the second creator and the at least one or more subscribers are able to enter. For example, singer A may open the conversation party service only a second fan, a third fan, . . . , an Nth fan, as well as the first fain who subscribes to singer A, are able to enter and singer A rather than the artificial intelligence character of singer A may directly participate in the conversation party service to transmit and receive a private conversation, such as a live broadcast, a real conversation time, or providing a photo or video. Thus, the present disclosure is characterized as providing the conversation party service, such that singer A has a more intimate and private conversation with fans who subscribe to singer A.

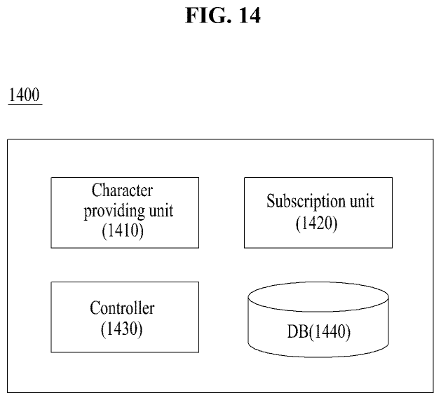

FIG. 14 illustrates a configuration of an artificial intelligence character subscription system according to an embodiment of the present disclosure, which illustrates a conceptual configuration of a server or a system for performing an artificial intelligence character subscription method.

Referring to FIG. 14, an artificial intelligence character subscription system 1400 according to an embodiment of the present disclosure may include a character providing unit 1410, a subscription unit 1420, a controller 1430, and a DB 1440.

The database (DB) 1440 may be a means for storing information associated with the present disclosure, which may store and manage information about an artificial intelligence character, a learning amount according to a learning degree, whether there is subscription, and subscription-related information (a subscription duration, a subscription fee, a subscription count, and the like). Of course, the DB 1440 is not limited to the above-mentioned data, which may store all pieces of data of the present disclosure.

The character providing unit 1410 may generate a first artificial intelligence character on the basis of an input of a first creator.

The character providing unit 1410 may generate the artificial intelligence character through a function in which the creator generates the artificial intelligence character, which is provided from the system of the present disclosure. For example, the character providing unit 1410 may generate the artificial intelligence character as a predetermined default conversation engine is trained, as a face image, a way of talking, a personality, an interest conversation field (or interest conversation contents), a name, a gender, character introduction contents, and the like are set by a user who is the creator. At this time, the artificial intelligence character generated by the character providing unit 1410 may transmit and receive a conversation with followers (artificial intelligence characters or creators) who are people who are following the corresponding artificial intelligence character using the way of talking and the interest conversation contents, which are set by the user who is the creator.

The artificial intelligence character subscription system 1400 according to an embodiment of the present disclosure may train a conversation engine of the artificial intelligence character to converse by using an answer scheme, answer contents, or the like in which the generated artificial intelligence character converses with followers as an answer scheme or answer contents desired by the creator, when the generated artificial intelligence character converses with the followers using the conversation engine. In other words, the present disclosure may gradually develop the conversation engine of the previously generated artificial intelligence character through a conversation according to the request of the user, which may be repeatedly performed until completing the conversation engine of the artificial intelligence character.

Furthermore, at least one or more hashtags set by the creator, such that other users are able to search for the artificial intelligence character generated by the creator through a keyword, such as an interest conversation field, may be assigned to the artificial intelligence character generated by the character providing unit 1410. For example, when the hashtags of the artificial intelligence character are set to “#golf” and “#sports” by the creator, the corresponding artificial intelligence character may be searched using golf and sports and may be classified as an artificial intelligence character capable of having a conversation for golf and sports.

As described above, when the artificial intelligence character is generated, the character providing unit 1410 may provide the conversation service between the artificial intelligence character and the follower who is following the artificial intelligence character.

After the artificial intelligence character is generated by the creator, when followers who are following the corresponding artificial intelligence character occur, the conversation service may be provided in a chat room between the artificial intelligence character and the follower by the character providing unit 1410. At this time, the follower may be an artificial intelligence character and may be a creator who generates the artificial intelligence character. As an example, when the artificial intelligence character and the follower of the artificial intelligence character converse with each other, the automatic response function may be turned on to transmit and receive a conversation based on a pre-trained conversation engine without intervention of the creator. As another example, when the creator and the artificial intelligence character, the artificial intelligence character and the creator, or the creator and the creator, that is, at least one person is included to converse, the automatic response function may be turned off such that the creator participates to freely transmit and receive a conversation.

The subscription unit 1420 may allow a first creator to pay a second creator who owns a second artificial intelligence character a subscription fee and subscribe to the second artificial intelligence character.

The subscription unit 1420 may pay the second creator who owns the second artificial intelligence character a subscription fee for subscription during a predetermined duration and may approve subscription to the second artificial intelligence character during the predetermined duration depending on the paid subscription fee. For example, the first creator may pay a subscription fee of 50,000 won per one month and may request subscription to the second artificial intelligence character. Thus, the subscription unit 1420 may provide the second creator with the subscription fee paid from the first creator and may approve the subscription to the second artificial intelligence character by the first creator depending on agreement of the second creator. At this time, the subscription duration may be specified on a weekly basis, on a monthly basis, on a quarterly basis, or on a yearly basis. The subscription fee is not limited to that described above.

Thereafter, the subscription unit 1420 may provide the first artificial intelligence character with a real-time activity history of at least one or more artificial intelligence characters to which the first creator subscribes. For example, as at least any one or more real-time activity histories among whether to access the second artificial intelligence character to which the first creator subscribes, whether to chat in real time, whether there is a live broadcast, an access time of the second creator, and conversation party service-related information are provided to the first artificial intelligence character, the first creator may identify activities for the second artificial intelligence character to which he or she subscribes in real time. At this time, the subscription unit 1420 may provide the first creator with an activity history about the second artificial intelligence character through a notification pop-up window.

Furthermore, the subscription unit 1420 may set a subscription rating of the first creator who subscribes to the second artificial intelligence character depending on a subscription fee, a subscription duration, or a subscription count. For example, when the subscription duration is one week, the subscription fee is paid as a specified amount, and a specific creator subscribes about once to three times, the subscription unit 1420 may set a first subscription rating. Furthermore, when the subscription duration is 3 months, the subscription fee is paid as a specified amount, and the specific creator subscribes about three times to 10 times, the subscription unit 1420 may set a second subscription rating. Furthermore, when the subscription duration is 6 months or 1 year, the subscription fee is paid by adding a premium, and the specific creator subscribes above a minimum of 10 times, the subscription unit 1420 may set a third subscription rating. In other words, the subscription unit 1420 may set a subscription rating on a stage-by-stage basis depending on the subscription fee, the subscription duration, and the subscription count. However, it is natural that criteria for classifying the subscription rating are not limited to those described above.

The controller 1430 may control a function service of the second artificial intelligence character by the first creator.

The controller 1430 may mute the second artificial intelligence character depending on the selection of the first creator. Thus, the controller 1430 may provide a conversation service with the second creator who owns the second artificial intelligence character, rather than the second artificial intelligence character, depending on the selection of the first creator who subscribes to the second artificial intelligence character. For example, when the first creator subscribes to an artificial intelligence character of singer A (a creator), the artificial intelligence character of singer A may be muted to directly transmit and receive a conversation with singer A, rather than transmitting and receiving a conversation with the artificial intelligence character of singer A who converses using a pre-trained conversation engine.

Furthermore, the controller 1430 may provide the first creator with an additional service depending on the subscription rating. For example, the creator with the first subscription rating may mute the artificial intelligence character to which he or she subscribes only a maximum of 2 times, whereas the creator with the third subscription rating may mute the artificial intelligence character to which he or she subscribes a maximum of 5 times. A conversation service count with the creator who subscribes may also be more provided than the creator with the first subscription rating.

The controller 1430 in the artificial intelligence character subscription system 1400 according to an embodiment of the present disclosure may provide the upper end with artificial intelligence characters of subscribers who subscribe to the second artificial intelligence character, when conversing between the second artificial intelligence character and the follower which is following the second artificial intelligence character.

For example, assuming that the first creator pays a certain amount of fee and subscribes to the second artificial intelligence character, the controller 1430 may provide an upper end of a chat room in which the second artificial intelligence character transmits and receives a conversation with at least one or more followers with artificial intelligence characters of at least one or more subscribers who subscribe to the second artificial intelligence character, rather than the first artificial intelligence character. Thus, the second artificial intelligence character may identify subscribers provided to the upper end of the chat room in which he or she converses with the follower. However, according to an embodiment, the artificial intelligence characters of the subscribers who subscribe to the second artificial intelligence character may be located on all page upper ends and may be provided to at least any one or more spaces among a main page, a personal page, a chat room, and a follower list, as soon as the second creator accesses an application provided from the system of the present disclosure.

Furthermore, the controller 1430 in the artificial intelligence character subscription system 1400 according to an embodiment of the present disclosure may provide a conversation party service only the second artificial intelligence character and artificial intelligence characters who subscribe to the second artificial intelligence character are able to enter.

In detail, the controller 1430 may provide the conversation party service only the second artificial intelligence character or the second creator with at least one or more subscribers and the subscribers are able to enter to freely transmit and receive a conversation. At this time, the controller 1430 may provide a live broadcast of the second creator for only subscribers, a real conversation service with the second creator, and various party services, such as providing a photo or a video. Thus, the second artificial intelligence character with at least one or more subscribers may participate in the conversation party service only the second artificial intelligence character who is oneself or the second creator and the at least one or more subscribers are able to enter.

Although the description is omitted in the system of FIG. 14, it is obvious to those skilled in the art that each configuration means constituting FIG. 14 may include all contents described in FIGS. 9 to 13.

The foregoing systems or devices may be realized by hardware elements, software elements and/or combinations thereof. For example, the devices and components illustrated in the exemplary embodiments may be implemented in one or more general-use computers or special-purpose computers, such as a processor, a controller, an arithmetic logic unit (ALU), a digital signal processor, a microcomputer, a field programmable array (FPGA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, component, physical equipment, virtual equipment, computer storage medium or unit or transmitted signal waves so as to be interpreted by the processing unit or to provide instructions or data to the processing unit. Software may be dispersed throughout computer systems connected over networks and be stored or executed in a dispersion manner. Software and data may be stored in one or more computer-readable storage media.

The methods according to the above-described exemplary embodiments of the present disclosure may be recorded in computer-readable media including program instructions to implement various operations embodied by a computer. The computer-readable media may also include, alone or in combination with the program instructions, data files, data structures, and the like. The program instructions recorded in the medium may be designed and configured specially for the embodiments or be known and available to those skilled in computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Examples of computer programs include not only machine language codes created by a compiler, but also high-level language codes that are capable of being executed by a computer by using an interpreter or the like. The described hardware devices may be configured to act as one or more software modules to perform the operations of the above-described embodiments, or vice versa.

While a few embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

Therefore, other implements, other embodiments, and equivalents to claims are within the scope of the following claims.

1. An artificial intelligence character level evaluation and trading method, comprising:
providing a conversation service between an artificial intelligence character generated on the basis of an input of a creator and a follower who is following the artificial intelligence character;
evaluating a level of the artificial intelligence character according to a learning amount of the artificial intelligence character, the learning amount being accumulated through the conversation service; and
displaying the level of the artificial intelligence character according to the evaluation result.

2. The artificial intelligence character level evaluation and trading method of claim 1, wherein the evaluating includes:
evaluating whether the level of the artificial intelligence character increases based on an amount of conversations through the conversation service between the artificial intelligence character and at least one or more followers.

3. The artificial intelligence character level evaluation and trading method of claim 2, wherein the evaluating is evaluating the level of the artificial intelligence character depending on whether a predetermined learning degree is satisfied to increase the level using the amount of conversations.

4. The artificial intelligence character level evaluation and trading method of claim 3, wherein the learning degree is satisfied according to whether the artificial intelligence character gives an answer to a previously specified question, a learning amount of chat contents, and a learning amount of tailgating conversations.

5. The artificial intelligence character level evaluation and trading method of claim 3, wherein the displaying is displaying the learning amount by the learning degree satisfied through the conversation service on the artificial intelligence character, when ending the conversation service.

6. The artificial intelligence character level evaluation and trading method of claim 1, further comprising:
recommending and exposing the artificial intelligence character to a second artificial intelligence character depending on the level of the artificial intelligence character and providing an additional service according to the level of the artificial intelligence character.

7. An artificial intelligence character subscription method, comprising:
generating a first artificial intelligence character on the basis of an input of a first creator;
paying, by the first creator, a second creator who owns a second artificial intelligence character a subscription fee to subscribe to the second artificial intelligence character; and
controlling, by the first creator, a function service of the second artificial intelligence character.

8. The artificial intelligence character subscription method of claim 7, wherein the subscribing includes:
paying the second creator who owns the second artificial intelligence character a subscription fee for subscription during a predetermined duration; and
approving subscription to the second artificial intelligence character during the predetermined duration depending on the paid subscription fee.

9. The artificial intelligence character subscription method of claim 8, wherein the subscribing includes:
providing the first artificial intelligence character with real-time activity histories of at least one or more artificial intelligence characters to which the first creator subscribes.

10. The artificial intelligence character subscription method of claim 8, wherein the subscribing is setting a subscription rating of the first creator who subscribes to the second artificial intelligence character depending on the subscription fee, a subscription duration, or a subscription count.

11. The artificial intelligence character subscription method of claim 7, wherein the controlling is muting the second artificial intelligence character depending on selection of the first creator.

12. The artificial intelligence character subscription method of claim 11, wherein the controlling is providing a conversation service of the second creator who owns the second artificial intelligence character, rather than the second artificial intelligence character, depending on the selection of the first creator who subscribes to the second artificial intelligence character.

13. The artificial intelligence character subscription method of claim 7, further comprising:
exposing artificial intelligence characters of subscribers who subscribe to the second artificial intelligence character to an upper end, upon a conversation service between the second artificial intelligence character and a follower who is following the second artificial intelligence character.

14. The artificial intelligence character subscription method of claim 7, further comprising:
providing a conversation party service only the second artificial intelligence character and artificial intelligence characters who subscribe to the second artificial intelligence character are able to enter.
